(19) United States
(12) Patent Application Publication
(10) Pub. No.: US 2017/0193540 A1
(43) Pub. Date: Jul. 6, 2017

(54) System, Method, and Apparatus for Outdoor Estimation

(71) Applicant: SITELITE, LLC, LARGO, FL (US)

(72) Inventor: Devon Papandrew, Tampa, FL (US)

(73) Assignee: SITELITE, LLC, LARGO, FL (US)

(21) Appl. No.: 15/226,936

(22) Filed: Aug. 3, 2016

Related U.S. Application Data
(60) Provisional application No. 62/273,914, filed on Dec. 31, 2015.

(51) Int. Cl. G06Q 30/02; G06Q 50/06

(52) U.S. Cl. CPC G06Q 30/0206; G06Q 50/06

(57) ABSTRACT

A system for preparing and presenting a proposal at a property utilizes wide-area networking to retrieve an aerial photograph or satellite image of the property, onto which a sales person indicates the locations, types, and specifications of fixtures on the property that are available for upgrade/replacement. Once the image/photograph is complete, the system accesses current pricing and installation costs for the fixtures and generates a proposal that is provided to the property owner. This system provides for a single visit to a property to gather fixture location, type, specification; generate proposals; and seal a deal with the property owner. Since the replacement fixtures are more energy efficient than those that are existing, the proposal utilizes local energy rates to determine the amount of time before the replacement fixtures pay for themselves in reduce energy consumption and cost.

### FIELD

This invention relates to making estimates for outdoor construction and more particularly to a system for estimating lighting needs based upon existing illumination.

### BACKGROUND

There are many situations in which a contractor/supplier needs to provide an estimate for a project. Many of these situations deal with estimating upgrades or replacement of existing outdoor items such as fixtures, landscaping, etc.

In recent years, newer lighting technologies have emerged that provide similar light output at drastically reduced energy consumption. One such technology uses light emitting diodes (LEDs) as a source of light. High power LEDs (e.g. arrays of LEDs) provide sufficient light output to illuminate parking lots, back yards, etc. As such lighting technologies consume lower amounts of energy (e.g. electricity), these lighting technologies also cost less to operate. The savings in electricity costs over a period of time provides a return on the investment for upgrading to such technologies. This return on investment is often used to make it attractive for the property owner on the upgrade, especially when such newer lighting technologies provide longer lasting light sources, as LEDs are known to operate for upwards of ten years without the need for replacement. This longer life also provides enhanced rates of return as fewer service calls are needed to replace failed lamps.

Currently, sales people will visit a property, draw a rough sketch of the property along with symbols for light fixtures, and note the size, type, and wattage of each light fixture. The sales person would then take the sketch home at night and prepares a drawing which includes the light fixtures, and then the sales person calculates the cost to replace each fixture to present a proposal to the property owner. This process is not only time consuming, but requires the sales person make at least two visits to the property, one to gather information and the other to present the proposal. Since two visits require the property owner be present twice, such is often an inconvenience for the property owner.

What is needed is a system that will develop a proposal on-site, requiring only one visit to the property.

### SUMMARY

A system for preparing and presenting a proposal at a property utilizes wide-area networking to retrieve an aerial photograph or satellite image of the property, onto which a sales person indicates the locations, types, and specifications of fixtures on the property that are available for upgrade/replacement. Once the image/photograph is complete, the system accesses current pricing and installation costs for the fixtures and generates a proposal that is provided to the property owner. This system provides for a single visit to a property to gather fixture location, type, specification; generate proposals; and seal a deal with the property owner. Since the replacement fixtures are more energy efficient than those that are existing, the proposal utilizes local energy rates to determine the amount of time before the replacement fixtures pay for themselves in reduce energy consumption and cost.

In some embodiments, the address of the property is used to find the aerial photograph and/or satellite image while in other embodiments; Global Positioning Service (e.g., GPS) technology is used to find the aerial photograph and/or satellite image.

In one embodiment, a system for outdoor estimation of a premise includes a device for accessing the system (e.g. a cell phone or tablet computer); the device has a location determining subsystem (e.g. Global Positioning System—GPS). A server has at least one map and an application running on the device for accessing the system determines a location of the outdoor estimation and communicates the location of the outdoor estimation to the server. The server responds with a map from the at least one map; the map corresponds to the location of the outdoor estimation. The application accepts inputs including data of an existing object at the premise and responsive to such, the application displays an icon representing the existing object and the application provides for moving the icon representing the existing object to a location on the map corresponding the a location of the existing object on the premise. The application then accesses a database of replacement objects and retrieves data regarding a replacement object that corresponds to the existing object and calculates a break-even time from the data of the existing object, the data regarding a replacement object, an energy cost, and an expected usage of the replacement object. The application then displays the data regarding the existing object, the data regarding the replacement object, and the break-even time.

In another embodiment, a method of outdoor estimation of a premise is disclosed including (a) determining a location of the outdoor estimation by a portable computing device and (b) sending the location of the outdoor estimation to a server. The server has at least one map. (c) The server responds with a map from the at least one map that corresponds to the location of the outdoor estimation. (d) The map is displayed on a display of the portable computing device. (e) inputs are accepted by the application; the inputs include data related to an existing lighting fixture at the premise. (f) Responsive to the inputs, the application displays an icon representing the existing lighting fixture on the map on the display. (g) Using the application, the icon representing the existing lighting fixture is relocated to a location on the map on the display corresponding to a location of the existing lighting fixture on the premise. (h) A database of replacement lighting fixtures is accessed by the application and data related to a replacement lighting fixture that corresponds to the existing lighting fixture is retrieved. (i) steps e-h are repeated for additional existing lighting fixtures at the premise. (j) The application calculates a break-even time from the data related to the existing lighting fixtures, the data related to the replacement lighting fixtures, an energy cost, and an expected usage time of the replacement lighting fixture and (k) displays the data regarding the existing lighting fixtures, the data regarding the replacement lighting fixtures, and the break-even time.

In another embodiment, program instructions tangibly embodied in a non-transitory storage medium comprising instructions running on a portable device for determining a location of the outdoor estimation and instructions for sending the location of the outdoor estimation to a server. The server has at least one map. Instructions running on the portable receive a map corresponding to the location of the outdoor estimation from the server and display the map on a display of the portable computing device. Instructions running on the portable device accept inputs. The inputs including data related to an existing lighting fixture at the premise. Responsive to the inputs, instructions running on the portable device display on the map on the display an icon representing the existing lighting fixture and relocate the icon representing the existing lighting fixture to a location on the map on the display corresponding the a location of the existing lighting fixture on the premise. Instructions running on the portable device access a database of replacement lighting fixtures and retrieving data related to a replacement lighting fixture that corresponds to the existing lighting fixture. The above steps are repeated for additional existing lighting fixtures at the premise. Instructions running on the portable device calculate a break-even time from the data related to the existing lighting fixtures, the data related to the replacement lighting fixtures, an energy cost, and an expected usage time of the replacement lighting fixture and displaying the data regarding the existing lighting fixtures, the data regarding the replacement lighting fixtures, and the break-even time.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the estimation and quoting system.

FIG. 2 illustrates a schematic view of a typical cell phone.

FIG. 3 illustrates a schematic view of a typical computer system such as a server or personal computer.

FIG. 4 illustrates a first user interface of the estimation and quoting system.

FIG. 5 illustrates a second user interface of the estimation and quoting system.

FIG. 6 illustrates a third user interface of the estimation and quoting system.

FIG. 7 illustrates a fourth user interface of the estimation and quoting system.

FIG. 8 illustrates a fifth user interface of the estimation and quoting system.

FIG. 9 illustrates a sixth user interface of the estimation and quoting system.

FIG. 10 illustrates a seventh user interface of the estimation and quoting system.

FIG. 11 illustrates an eighth user interface of the estimation and quoting system.

FIG. 12 illustrates a ninth user interface of the estimation and quoting system.

FIG. 13 illustrates a tenth user interface of the estimation and quoting system.

FIG. 14 illustrates an eleventh user interface of the estimation and quoting system.

FIG. 15 illustrates a twelfth user interface of the estimation and quoting system.

FIG. 16 illustrates an exemplary program flow of the estimation and quoting system.

FIG. 17 illustrates a second exemplary program flow of the estimation and quoting system.

FIG. 18 illustrates a third exemplary program flow of the estimation and quoting system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the estimation and quoting system accesses an aerial photograph or satellite image and displays such on a display of a computer device. Onto that image, a salesperson indicates location, type, and specification of various fixtures that exist on the property and, once complete, the system for outdoor estimation used up-to-date replacement fixture cost and installation cost data to generate a proposal. Utilizing local electricity costs, the system for outdoor estimation also generates an estimated break-even date (time to break even), indicating when the replacement fixtures will pay for themselves. Although the term “sales person” is used throughout to indicate the person who utilizes the system for outdoor estimation and enters the data, there is no restriction as to who or the type of person who will perform such activities.

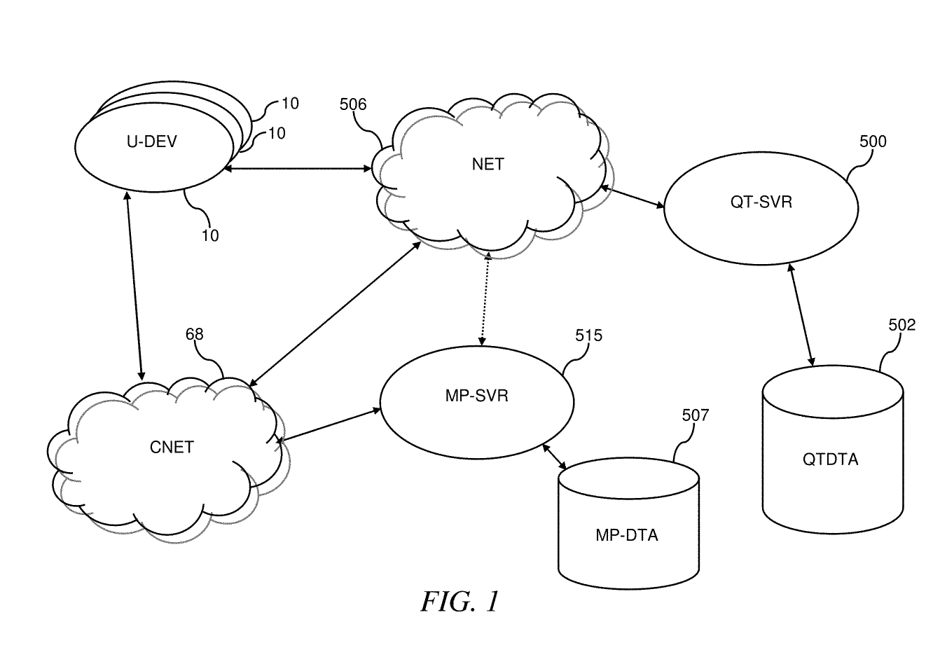

Referring to FIG. 1 illustrates a data connection diagram of the exemplary system for outdoor estimation. In this example, one or more computing devices 10 such as tablet computers communicate through the cellular network 68 and/or through a wide area network 506 (e.g. the Internet) to a server computer 500.

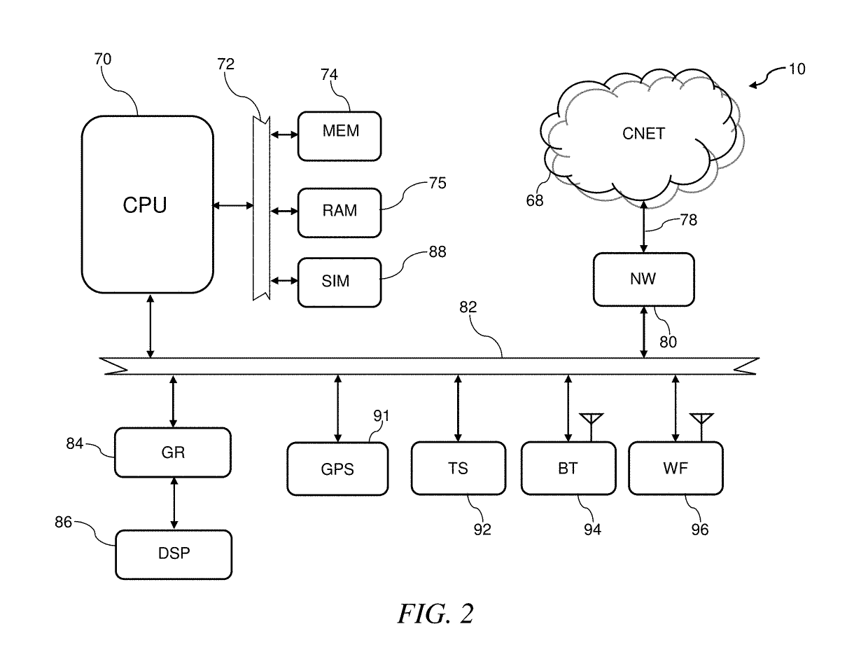

The server computer 500 has access to data storage 502, for example for storing a database of replacement devices 404. Although one path between the computing devices 10 and the server 500 is through the cellular network 68 and/or the wide area network 506 as shown, any known data path is anticipated. For example, the Wi-Fi transceiver 96 (see FIG. 2) of the computing device 10 is used to communicate directly with the wide area network 506, which includes the Internet, and, consequently, with the server computer 500.

The server computer 500 transacts with the computing devices 10 through the network(s) 68/506 to present menus to/on the computing devices 10, provide data to the computing devices 10, and to communicate information such as the salesperson's location, etc. In some embodiments, the salesperson's login credentials (e.g., passwords, pins, secret codes) are stored local to the computing device 10; while in other embodiments, login credentials are stored in a data storage 502 (preferably in a secured area) requiring a connection to the server before login.

The server computer 500 transacts with applications running on the computing devices 10.

In some embodiments, when the system for outdoor estimation application initiates on the computing device 10, the geographic area of the computing device 10 is determined by reading the GPS subsystem 91 (see FIG. 2) of the computing device 10 or by manual entry by a salesperson. Manual entry by a salesperson is made by, for example, entering a street address or by selecting/panning to a location on a map.

The location from the GPS subsystem 91 is forwarded to the server 500 during initialization and periodically while the system for outdoor estimation application is active so as to keep the server 500 informed of location changes.

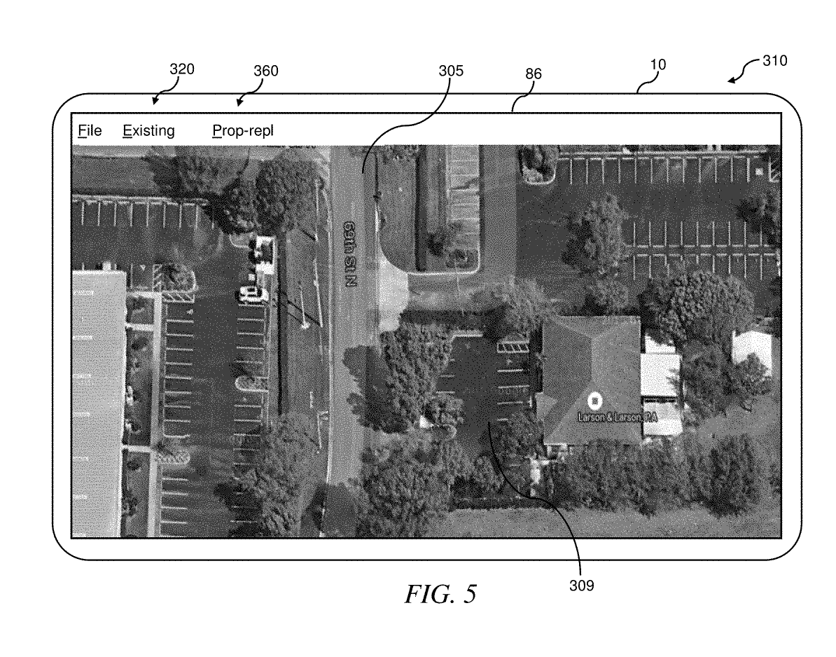

The computing device 10 communicates with the server 500 and/or with an image/map server 515 to retrieve an aerial photograph or satellite image mapping 305 (see FIGS. 5-11) based upon a location that is either directed from a GPS 91 or a location that is entered into the application by the sales person (e.g., street address, latitude/longitude, etc.). As will be shown, the aerial photograph or satellite image mapping 305 is adjustable (pan, zoom-in, zoom-out, crop, etc.) and there are directives for the salesperson to enter data directly associated with and appearing as overlays on the aerial photograph or satellite image mapping 305.

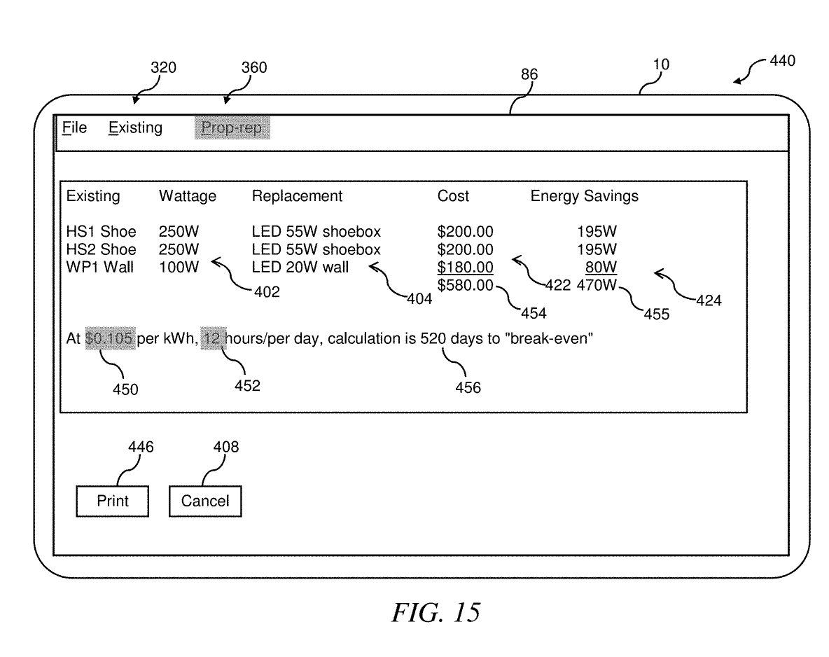

Referring to FIG. 2, a schematic view of a typical computing device 10 is shown. The example computing device 10 represents a typical cell phone or tablet system used for accessing user interfaces (see FIGS. 5-15) of the estimation and quoting system. This exemplary computing device 10 is shown in its simplest form. Different architectures are known that accomplish similar results in a similar fashion and the present invention is not limited in any way to any particular computing device 10 system architecture or implementation. In this exemplary computing device 10, a processor 70 executes or runs programs in a random access memory 75. The programs are generally stored within a persistent memory 74 and loaded into the random access memory 75 when needed. Also accessible by the processor 70 is a SIM (subscriber information module) card 88 having a subscriber identification and often persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, magnetic memory, etc. In some exemplary computing devices 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted as a display image on the display 86. The touch screen interface 92 provides navigation and selection features.

In general, some portion of the persistent memory 74 and/or the SIM card 88 is used to store programs, executable code, phone numbers, contacts, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, Bluetooth transceiver 94, Wi-Fi transceiver 96, image sensors, temperature sensors, etc., the details of some of which are not shown for brevity and clarity reasons.

The cellular network interface 80 connects the computing device 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the computing device 10 through the cellular network.

For local-area communications, in some embodiments, the computing devices 10 include a Bluetooth transceiver 94, a Wi-Fi transceiver 96, or both. Such features of computing devices 10 provide data communications between the computing devices 10 and data access points and/or other computers such as a personal computer (not shown).

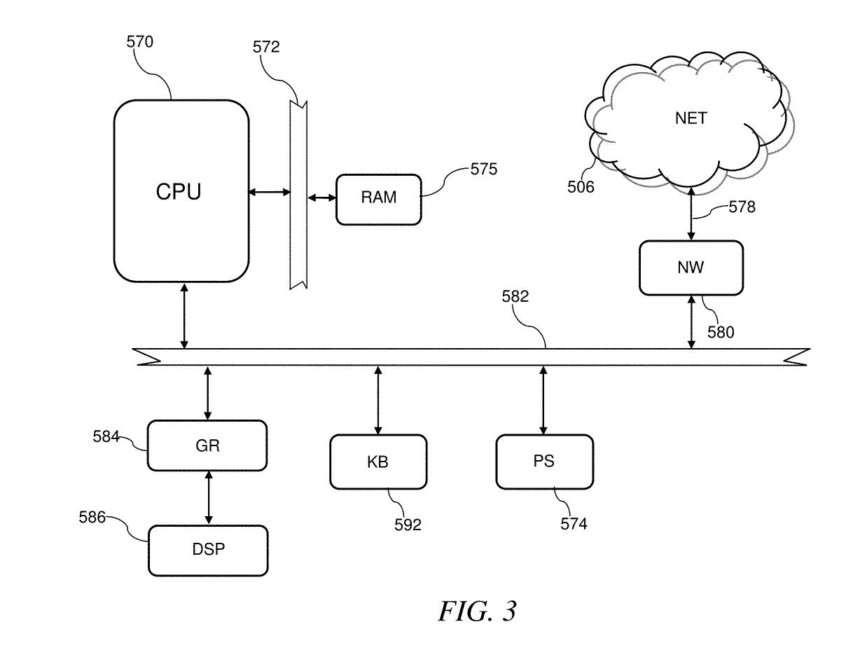

Referring to FIG. 3, a schematic view of a typical computer system (e.g., server 500) is shown. The example computer system 500 represents a typical computer system used for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory 574 is used to store programs, executable code, voter data, contacts, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

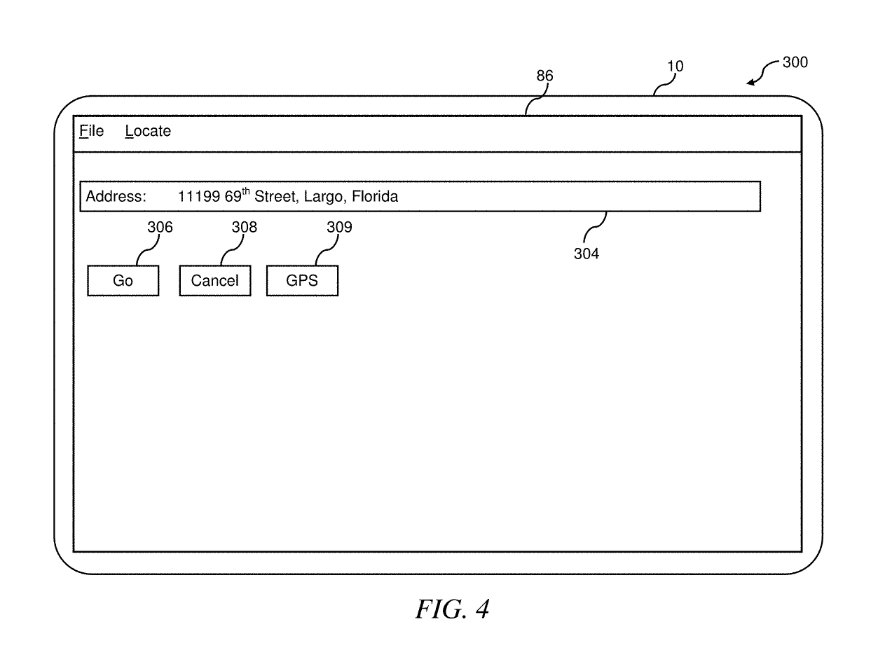

Referring to FIGS. 4-15, exemplary user interfaces of the estimation and quoting system are shown. Although many user interfaces are anticipated, one set of examples are shown. Although there are user interfaces that utilize a browser running on the user device (e.g., computing device 10), the examples shown utilize an application that runs on the user device (e.g. computing device 10). For brevity, in the remainder of the description, it is assumed that the computing device 10 is a tablet computer.

In some embodiments, a log-in/register user interface is included, as such is well known in the art, it is not shown for brevity reasons.

In FIG. 4, a sample starting user interface 300 is shown. In this, the display of the computing device 10 shows an interface 300 that indicates a current address 304 and has directives 306/308/309 as to what is done next. Selecting “GPS” 309 accesses the Global Positioning System (GPS) 91 of the computing device 10 to re-read the current location. It is also anticipated that the GPS 91 be read at start-up to determine the location of the computing device 10. Selecting “Cancel” 308 cancels the operation.

Selecting “Go” 306 initiates a transaction to the server 500 and/or the map server 515. The computing device 10 sends the server 500 and/or the map server 515 a transaction including the location of the computing device 10, for example, the coordinates returned from the GPS 91 or a street address 304. The server 500 and/or the map server 515 use the location to find a map 305 that corresponds to that location (see FIGS. 5-14). Responsive to this transaction, the map 305 is sent from the server 500 and/or the map server 515 to the computing device 10. In one embodiment, satellite maps are stored in the map data 507 of the map server 515 and a map 305, subset of a map 305, or superset of a map 305 (e.g. a larger geographic area than is to be displayed) is sent back from the map server to the computing device 10.

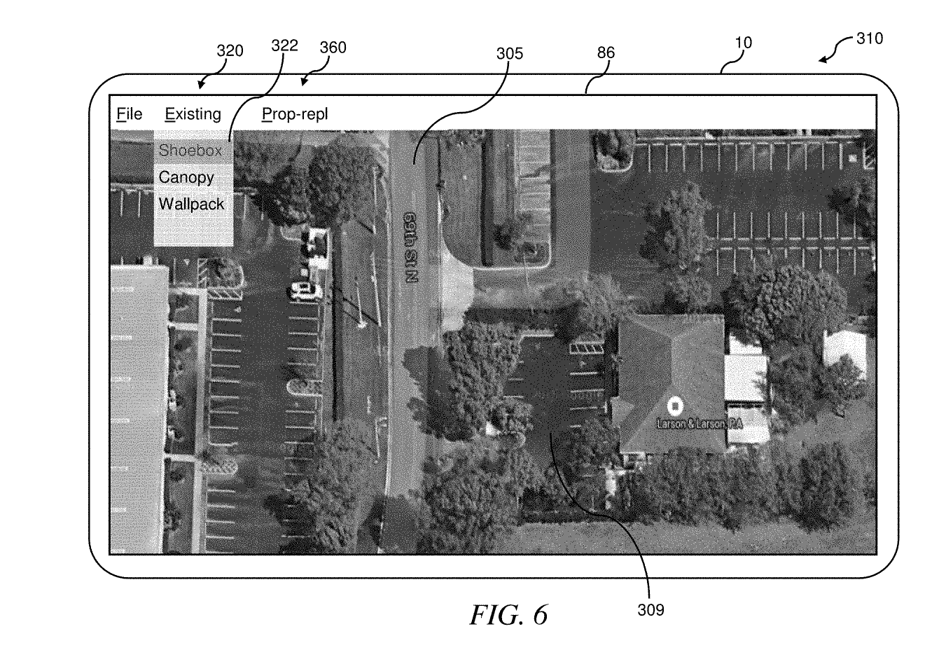

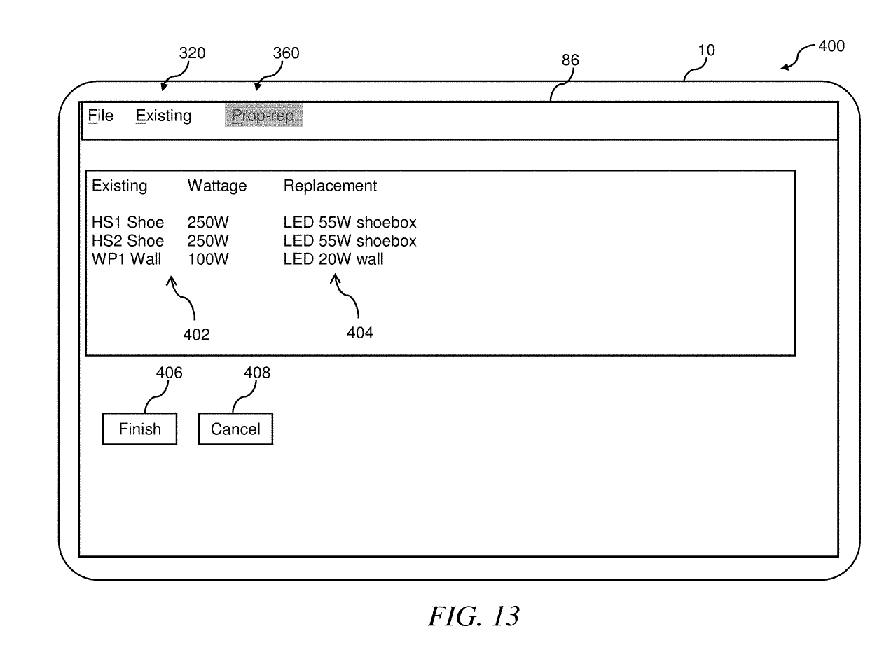

Referring to FIG. 5, the map 305 is the displayed as, for example, in user interface 310. In this example, a property 309 is shown that has a parking lot. The user of the computing device then utilizes selects the “Existing” 320 directive to systematically annotate the property 309, indicating the existing device 402 (see FIG. 13) and a proposed replacement device for each location as is explained with FIGS. 6-12. The “Prop-rep” directive 360 is explained later.

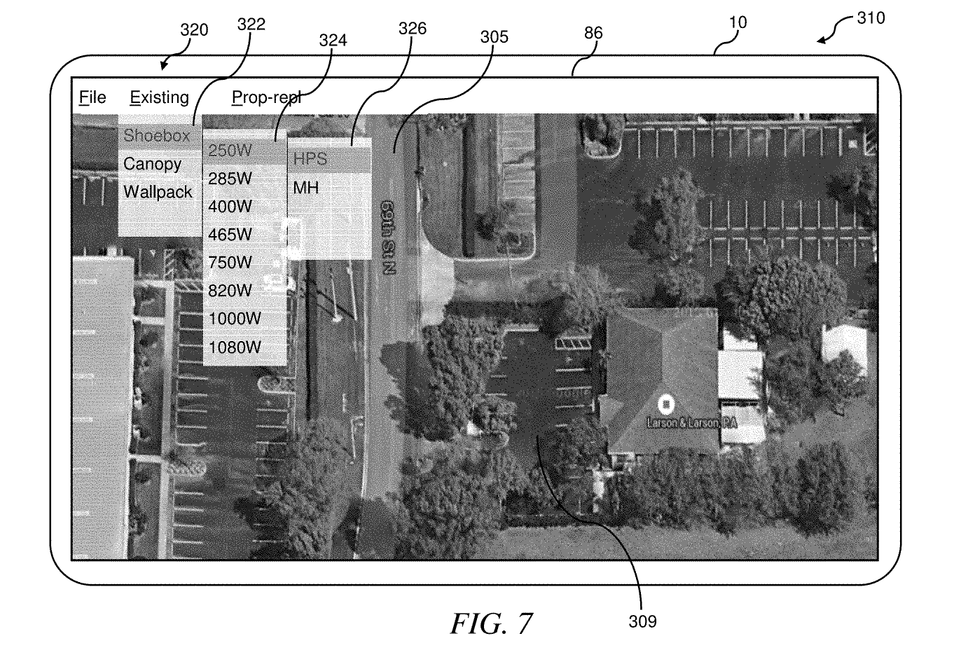

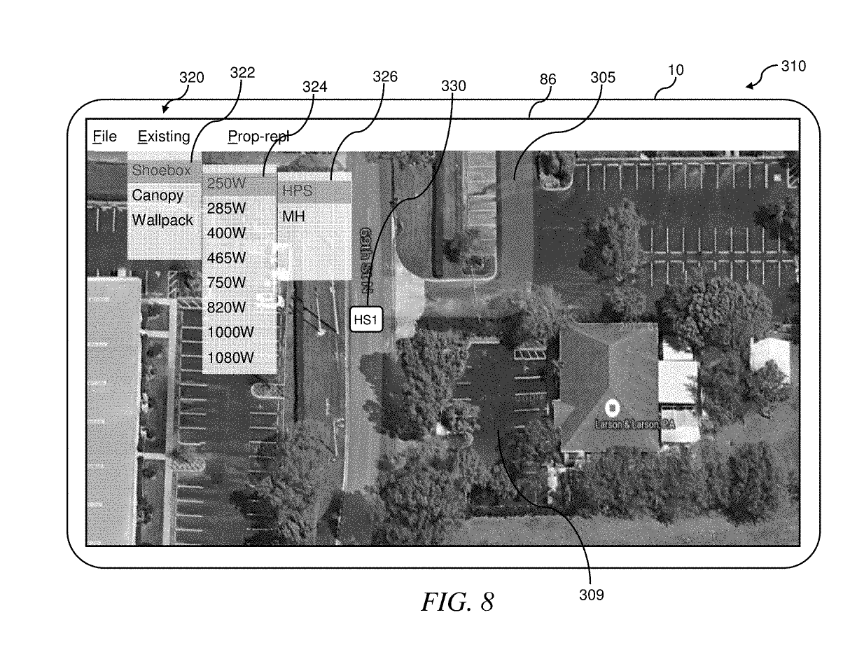

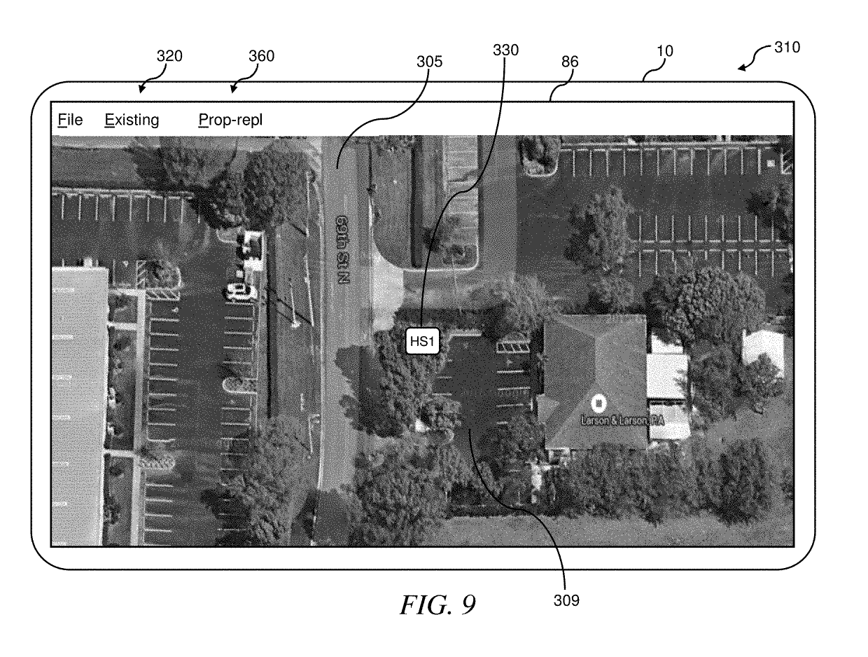

Referring to FIGS. 6-12, a series of user interfaces are shown providing exemplary user interfaces for recording of existing devices 402 on the property 309 and for proposing suggested replacement devices for the existing devices 402. As shown in FIG. 6, the “Existing” directive 320 is a pull-down menu and, upon selecting the “Existing” directive 320, a first pull-down menu 322 consisting of “Shoebox,” “Canopy,” and “Wallpack” devices is displayed. Selecting of the “Shoebox,” entry opens a second pull-down menu 324 as shown in FIG. 7, listing values of the devices (e.g. light wattages) that are known—from 250 Watt to 1080 Watt. Selecting the 250 Watt line presents a third drop-down menu 326 for selecting the technology of device that is possible with the selected value, for example, HPS (High Pressure Sodium) and MH (Metal Halide) as shown in FIG. 8. Upon selecting the technology (in this example, HPS 326), an existing device icon 330 is displayed (e.g. HS1). Now, the existing device icon 330 is dragged to the location where this existing device 402 is on the property 309 as shown in FIG. 9. Any level and hierarchy of pull-down menus 322/324/326 are anticipated depending upon the technologies or devices being proposed. For example, in a landscaping example, a first level pull-down might be for a type of item (e.g. tree, bush, plant, flower-bed, rock, rock-bed, etc.) and a second level might be for a type (e.g. red rock, grey rock, river rock, etc.) and a third level might be for the size (e.g. 1″, 2″, 3-4″, etc).

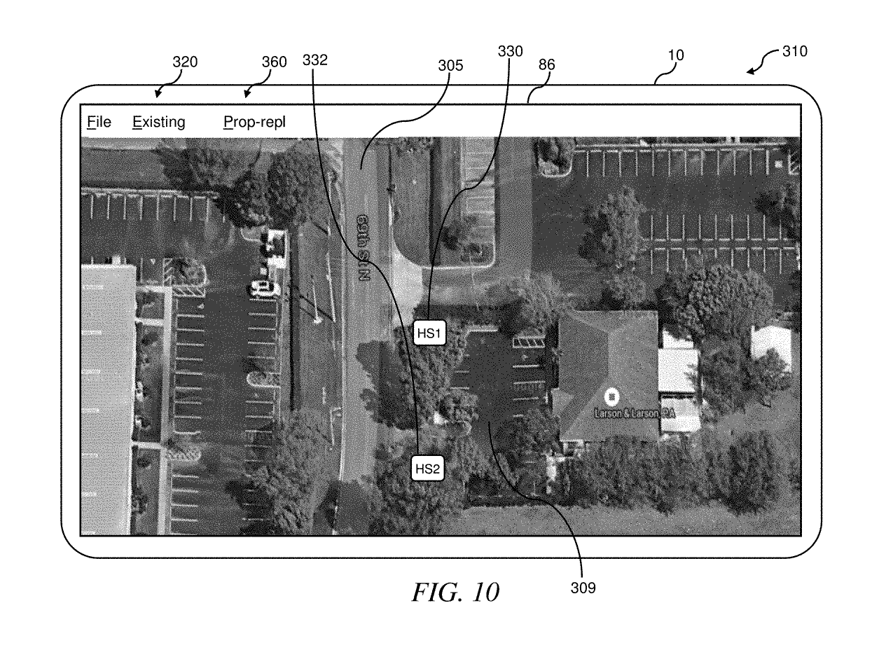

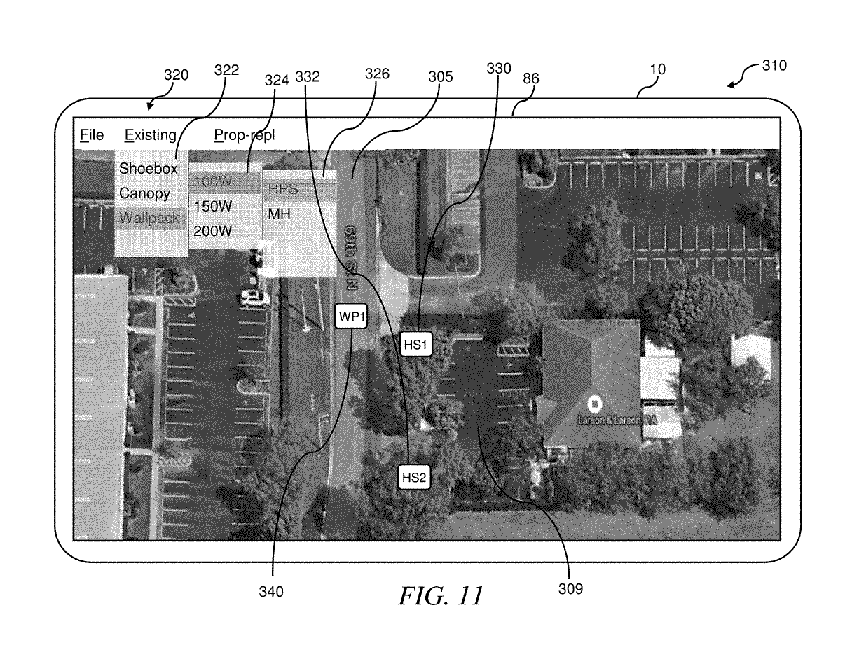

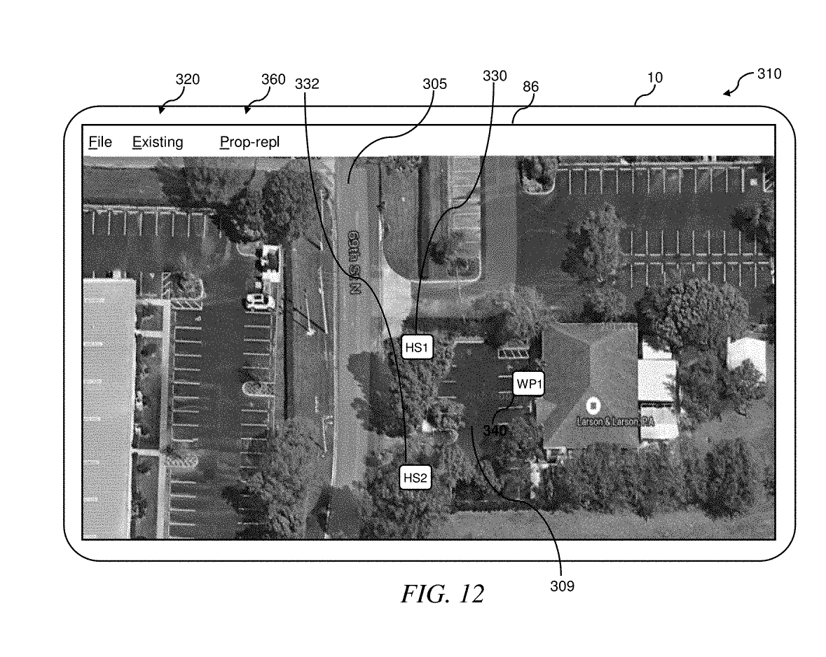

Referring to FIG. 10, the above steps have been repeated to add and place a second existing device 402, HS1 device icon 332. In FIG. 11, the above steps have been repeated to create a third existing device 402, WP1 icon (Wall Pack) 340 and in FIG. 12, the third existing device 402, WP1 (Wall Pack) 340 is shown being placed against a building of the property 309. Any number of device icons 330/332/334 is added as a user investigates the property 309. Once all device icons 330/332/334 have been added, the “prop-rep” directive is selected and flow proceeds to the calculating menu 400 shown in FIG. 13.

Referring to FIG. 13, the calculating menu 400 is shown. A list of the existing devices 402 is shown along with proposed replacement devices 404. For example, the first line of the list of the existing devices 402 and replacement devices 404 shows an existing high pressure sodium shoebox device with a value of 250 Watts and a suggested replacement device being an LED 55 W shoebox. It is fully anticipated that, in some embodiments, editing facilities are available to change one or more of the existing devices 402 and/or replacement devices 404. For example, should the owner of the property 309 need a brighter replacement device 404 and/or a different color temperature replacement device 404. In another example, a mistake is made and the existing fixture needs to be changed to a different wattage, etc.

Once the list of existing devices 402 and corresponding replacement devices 404 is complete, the “Finish” directive 406 is selected and flow continues with the user interface 420 of FIG. 13. A “Cancel” directive 406 is shown for completeness.

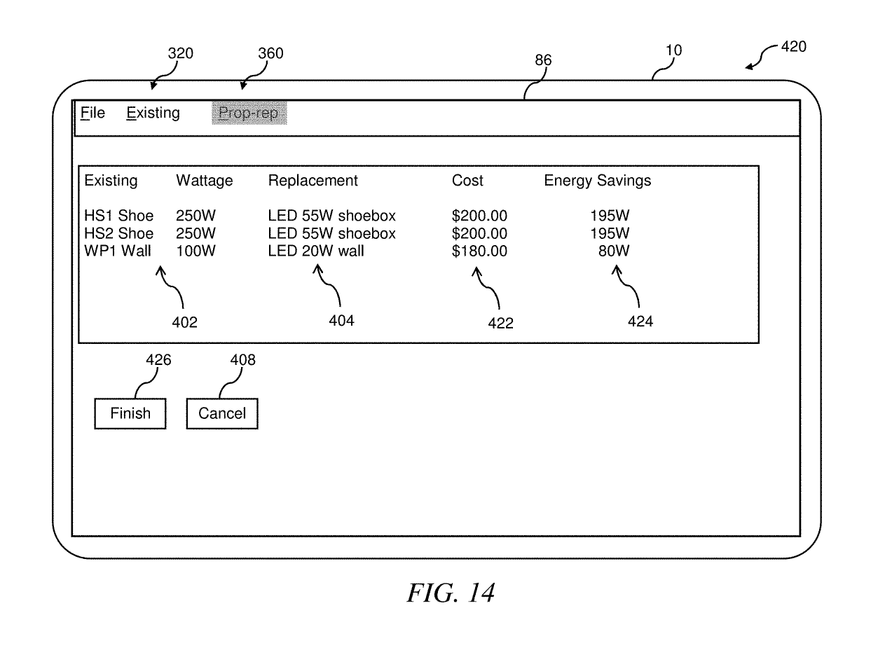

Referring to FIG. 13, user interface 420 shows the costs 422 to provide and install and energy savings 424 from each replacement device 404. Again, in some embodiments, editing features are provided to enable changes to the costs 422 and/or energy savings 424, for example, to provide discounts, etc. Once costs 422 and/or energy savings 424 is complete, the “Finish” directive 426 is selected and flow continues with the user interface 440 of FIG. 14.

Referring to FIG. 14, user interface 440 shows the costs 422 to provide and install and energy savings 424 from each replacement device 404, the costs 422 and the energy savings 424. A new line is displayed indicating how long it will take the replacement devices 404 to “pay for themselves.” As newer, more efficient technology is introduced, the cost of purchase and installation is offset by savings in the costs of energy consumption. For example, replacing a 250 Watt device with a 55 W device saves 195 Watt-hours of energy for every hour that the device is used. In the example shown in the interface 440, a local cost per Kilowatt-hour 450 and an expected number of hours-per-day 452 is displayed (e.g., $0.105 per Kilowatt-hour and 12 hours per day). Using the local cost per Kilowatt-hour 450 and expected number of hours-per-day 452 in conjunction with the total cost 454 and the total energy savings 455, a number of days to break-even 456 is calculated and displayed. Again, in some embodiments, editing features are provided to change the local cost per Kilowatt-hour 450 and the expected number of hours-per-day 452, etc.

In some embodiments, the user interface 440 includes a print directive 446 and a cancel directive 406. It is anticipated that the user (e.g. estimator, salesperson) has a portable printer for printing the proposal at the property 309 and/or saves the proposal and prints the proposal at a different location that has a printer.

In some embodiments, data used to determine the replacement devices 404 and default values for the local cost per Kilowatt-hour 450 and expected number of hours-per-day 452 are stored locally to the computing device 10, for example, downloaded from the server 500. In some embodiments, the data used to determine the replacement devices 404 and default values for the local cost per Kilowatt-hour 450 and expected number of hours-per-day 452 are retrieved from the server 500. In some embodiments, the calculations of the total cost 454, the total energy savings 455, and the number of days to break-even 456 are calculated by computing device 10. In some embodiments, the calculations of the total cost 454, the total energy savings 455, and the number of days to break-even 456 are calculated by the server 500.

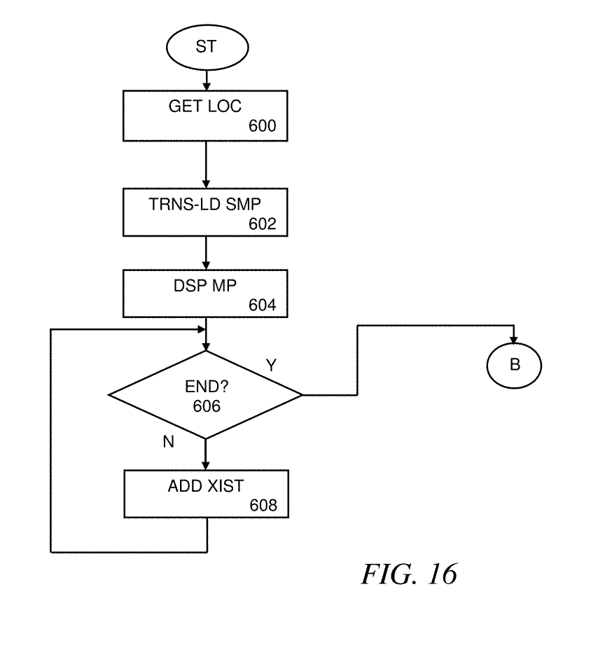

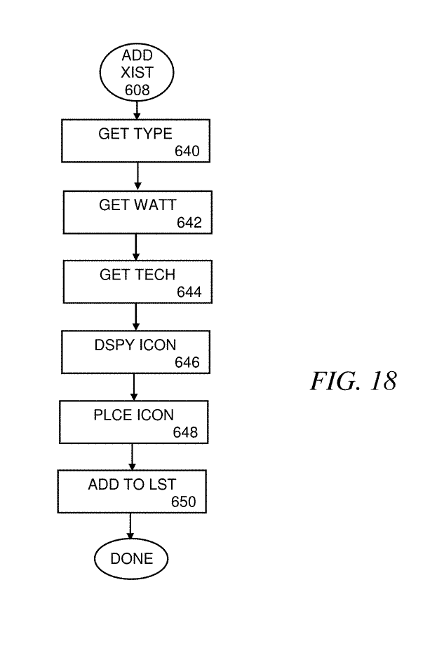

Referring to FIGS. 16-18, exemplary program flows of the estimation and quoting system are shown. In FIG. 16, the flow starts with getting the location 600 (for example, reading a GPS system 91 of the computing device 10 or entering a street address 304). A transaction is made with either the server 500 and/or the map server 515 providing the location and receiving back a map 305, for example, a satellite image of the area around the location. The map is displayed 604. Next, until ending 606, an add-existing procedure 608 as described in FIG. 18 is performed. The add-existing procedure 608 obtains the type and location of each existing device 402.

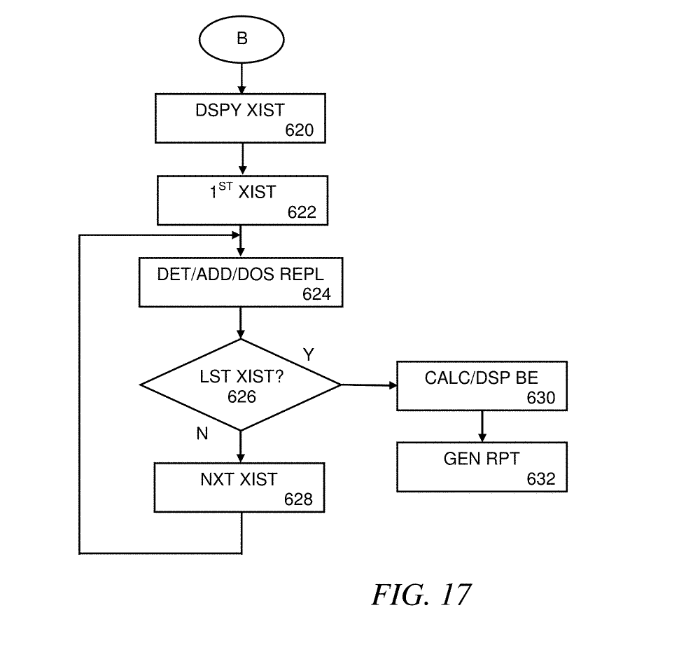

Upon ending 606 (e.g., all existing devices 402 have been added), flow continues with displaying 620 the list of existing devices 402 as shown in FIG. 17. The first existing device 402 is selected 622 and a loop begins 624/626/628 in which, for each existing device 402, a replacement device 404 is determined and added/displayed 624, along with the costs and energy savings for the replacement device 404. If there are still more 626 existing device 402, the next existing device 402 is selected 628 and the loop 624/626/628.

Once there are no more 626 existing devices 402, the break-even time is calculated and displayed (e.g., number of days until breaking even on the investment of installing replacement devices 404) and a report/proposal is generated 632 for printing and/or sending to the owner of the property 309.

Referring to FIG. 18, the add-existing procedure 608 is described. The add-existing procedure 608 begins with getting the type 640 of existing device 402 (e.g. shoebox, canopy, wallpack), getting the wattage/size 642 of existing device 402 (e.g. 100 W, 150 W, 200 W), then getting the technology 644 of existing device 402 (e.g. e.g., halogen, high pressure sodium, metal halide). Once obtained, an existing device icon 330/332/340 is displayed 646 on the display 86 of the computing device 10. The existing device icon 330/332/340 represents the existing device 402 as entered in the above steps 640/642/644. Now, the existing device icon 330/332/340 is placed 648 at the location on the map 305 corresponding to that existing device 402. Using user interface technology that is known for moving an object on a display, the existing device icon 330/332/340 is relocated on the map 305 to the location on the property 309 at which the existing device 402 is located. After placement of the existing device icon 330/332/340, the existing device 402 (e.g. type, wattage/size, technology, location) is added to the list of existing devices 402.

It is anticipated that portions of the exemplary program flow execute on a user device such as a computing device 10 while portions of the exemplary program flow execute on the server 500 and/or map server 515.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for outdoor estimation of a premise, the system comprising:
a device for accessing the system, the device having a location determining subsystem;
a server, the server having at least one map;
an application running on the device for accessing the system determines a location of the outdoor estimation and communicates the location of the outdoor estimation to the server, the server responding with a map from the at least one map, the map corresponding to the location of the outdoor estimation;
the application accepts inputs including data of an existing object at the premise and responsive to such, the application displays an icon representing the existing object, the application provides for moving the icon representing the existing object to a location on the map corresponding the a location of the existing object on the premise;
the application accesses a database of replacement objects and retrieves data regarding a replacement object that corresponds to the existing object;
the application calculates a break-even time from the data of the existing object, the data regarding a replacement object, an energy cost, and an expected usage of the replacement object; and
the application displays the data regarding the existing object, the data regarding the replacement object, and the break-even time.

2. The system of claim 1, wherein the existing object is an existing lighting fixture.

3. The system of claim 2, wherein the replacement object is a replacement lighting fixture.

4. The system of claim 3, wherein the replacement lighting fixture is more energy efficient than the existing lighting fixture.

5. The system of claim 1, whereas the application running on the device for accessing the system determines the location of the outdoor estimation by reading text input.

6. The system of claim 1, whereas the application running on the device for accessing the system determines the location of the outdoor estimation by reading the location determining subsystem.

7. The system of claim 1, wherein the map is a satellite map.

8. The system of claim 1, whereas the application further formats and prints the data regarding the existing object, the data regarding the replacement object, and the break-even time for presenting a proposal to a representative of the premise.

9. A method of outdoor estimation of a premise, the method comprising:
(a) determining a location of the outdoor estimation by a portable computing device;
(b) sending the location of the outdoor estimation to a server, the server having at least one map;
(c) the server responding with a map from the at least one map, the map corresponding to the location of the outdoor estimation;
(d) displaying the map on a display of the portable computing device;
(e) accepting inputs by the application, the inputs including data related to an existing lighting fixture at the premise;
(f) responsive to the inputs, the application displaying on the map on the display an icon representing the existing lighting fixture;
(g) using the application, relocating the icon representing the existing lighting fixture to a location on the map on the display corresponding the a location of the existing lighting fixture on the premise;
(h) accessing a database of replacement lighting fixtures by the application and retrieving data related to a replacement lighting fixture that corresponds to the existing lighting fixture;
(i) repeating steps e-h for additional existing lighting fixtures at the premise;
(j) the application calculating a break-even time from the data related to the existing lighting fixtures, the data related to the replacement lighting fixtures, an energy cost, and an expected usage time of the replacement lighting fixture; and
(k) displaying by the application the data regarding the existing lighting fixtures, the data regarding the replacement lighting fixtures, and the break-even time.

10. The method of claim 9, further comprising a step of printing by the application the data regarding the existing lighting fixtures, the data regarding the replacement lighting fixtures, and the break-even time.

11. The method of claim 9, wherein the energy cost and the expected usage time of the replacement lighting fixture are default values.

12. The method of claim 11, further comprising a step of editing the energy cost and/or the expected usage time of the replacement lighting fixture using the application.

13. The method of claim 9, whereas the step of determining a location of the outdoor estimation by the portable computing device includes reading text input by the application.

14. The method of claim 9, whereas the step of determining a location of the outdoor estimation by the portable computing device includes reading a measurement from a global positioning subsystem.

15. The method of claim 9, wherein the map is a satellite map.

16. Program instructions tangibly embodied in a non-transitory storage medium, wherein the at least one instruction comprises:
a. computer readable instructions running on a portable device determining a location of the outdoor estimation;
b. computer readable instructions running on the portable device sending the location of the outdoor estimation to a server, the server having at least one map;
c. computer readable instructions running on the portable receiving a map of the at least one map corresponding to the location of the outdoor estimation from the server;
d. computer readable instructions running on the portable device displaying the map on a display of the portable computing device;
e. computer readable instructions running on the portable device accepting inputs, the inputs including data related to an existing lighting fixture at the premise;
f. responsive to the inputs, computer readable instructions running on the portable device displaying on the map on the display an icon representing the existing lighting fixture;
g. computer readable instructions running on the portable device relocating the icon representing the existing lighting fixture to a location on the map on the display corresponding the a location of the existing lighting fixture on the premise;
h. computer readable instructions running on the portable device accessing a database of replacement lighting fixtures and retrieving data related to a replacement lighting fixture that corresponds to the existing lighting fixture;
i. computer readable instructions running on the portable device repeating steps e-h for additional existing lighting fixtures at the premise;
j. computer readable instructions running on the portable device calculating a break-even time from the data related to the existing lighting fixtures, the data related to the replacement lighting fixtures, an energy cost, and an expected usage time of the replacement lighting fixture; and
k. computer readable instructions running on the portable device displaying the data regarding the existing lighting fixtures, the data regarding the replacement lighting fixtures, and the break-even time.

17. The program instructions tangibly embodied in a non-transitory storage medium of claim 16, further comprising computer readable instructions running on the portable device printing the data regarding the existing lighting fixtures, the data regarding the replacement lighting fixtures, and the break-even time

18. The program instructions tangibly embodied in a non-transitory storage medium of claim 16, whereas the computer readable instruction running on the portable device for determining the location of the outdoor estimation includes computer readable instruction running on the portable device for reading text input.

19. The program instructions tangibly embodied in a non-transitory storage medium of claim 16, whereas the computer readable instruction running on the portable device for determining the location of the outdoor estimation includes computer readable instruction running on the portable device for reading a measurement from a global positioning subsystem of the portable device.

20. The program instructions tangibly embodied in a non-transitory storage medium of claim 16, wherein the map is a satellite map.
